(19) United States
(12) Patent Application Publication
(10) Pub. No.: US 2023/0191381 A1
(43) Pub. Date: Jun. 22, 2023

(54) USE OF MTW-ZEOLITE IN SUPPORT FOR HYDROCRACKING CATALYSTS WITH IMPROVED SELECTIVITY AND COLD FLOW PROPERTY OF MIDDLE DISTILLATE

(71) Applicant: Chevron U.S.A. Inc., San Ramon, CA (US)

(72) Inventors: Bi-Zeng ZHAN, Albany, CA (US); Ann Jia-Bao LIANG, Walnut Creek, CA (US); Theodorus Ludovicus Michael MAESEN, Moraga, CA (US)

(21) Appl. No.: 17/999,535

(22) PCT Filed: May 14, 2021
(86) PCT No.: PCT/US2021/032561

§ 371 Date: Nov. 21, 2022

Related U.S. Application Data
(60) Provisional application No. 63/028,069, filed on May 21, 2020.

(51) Int. Cl. B01J 29/80; B01J 21/12; B01J 29/16; B01J 29/78; B01J 23/888; B01J 31/02; B01J 37/00; B01J 37/08; B01J 37/02; C10G 47/20

(52) U.S. Cl. CPC B01J 29/80; B01J 21/12; B01J 29/166; B01J 29/7815; B01J 29/7869; B01J 23/888; B01J 31/0202; B01J 37/0018; B01J 37/08; B01J 37/0213; B01J 37/0203; B01J 37/0236; C10G 47/20; B01J 2029/062

(57) ABSTRACT

The process comprises hydrocracking a hydrocarbon feed in a single stage. The catalyst comprises a base impregnated with metals from Group 6 and Groups 8 through 10 of the Periodic Table. The base of the catalyst used in the present hydrocracking process comprises alumina, an amorphous silica-alumina (ASA) material, a USY zeolite, optionally a beta zeolite, and zeolite ZSM-12.

### CROSS REFERENCE TO RELATED APPLICATIONS

This application is the national stage application of International Appl. No. PCT/US21/032561 (doc. no. T-11261), filed on May 14, 2021, and is related to, and claims priority benefit from U.S. Provisional Patent Appl. Ser. No. 63/028,069, filed on May 21, 2020, entitled “USE OF MTW-ZEOLITE IN SUPPORT FOR HYDROCRACKING CATALYSTS WITH IMPROVED SELECTIVITY AND COLD FLOW PROPERTY OF MIDDLE DISTILLATE”, the disclosures of which are herein incorporated by reference in their entirety.

### BACKGROUND

Catalytic hydroprocessing refers to petroleum refining processes in which a carbonaceous feedstock is brought into contact with hydrogen and a catalyst, at a higher temperature and pressure, for the purpose of removing undesirable impurities and/or converting the feedstock to an improved product. Examples of hydroprocessing processes include hydrotreating, hydrodemetallization, hydrocracking and hydroisomerization processes.

A hydroprocessing catalyst typically consists of one or more metals deposited on a support or carrier consisting of an amorphous oxide and/or a crystalline microporous material (e.g., a zeolite). The selection of the support and metals depends upon the particular hydroprocessing process for which the catalyst is employed.

It is well known that zeolites play a key role in hydrocracking and hydroisomerization reactions, and the pore structures of zeolites largely dictate their catalytic selectivity. The two processes achieve different results and different catalysts are required.

Hydrocracking refers to a process in which hydrogenation and dehydrogenation accompanies the cracking/fragmentation of hydrocarbons, e.g., converting heavier hydrocarbons into lighter hydrocarbons, or converting aromatics and/or cycloparaffins (naphthenes) into non-cyclic branched paraffins. Hydroisomerization refers to a process in which normal paraffins are isomerized to their more branched counterparts in the presence of hydrogen over a catalyst.

Hydrocracking is quite useful in producing distillate fuels. Creating new catalyst combinations that can focus and improve the conversion and yield of desired distillate products by hydrocracking processes would be of great use to the industry.

### SUMMARY

It has been discovered that utilizing the novel catalyst of the present process in a hydrocracking process improves the middle-distillate production. The process comprises hydrocracking a hydrocarbon feed in a single stage. The catalyst used in the single stage of the present hydrocracking process comprises a base impregnated with metals from Group 6 and Groups 8 through 10 of the Periodic Table. The base of the catalyst used in the single hydrocracking stage comprises alumina, an amorphous silica-alumina (ASA) material, a USY zeolite and zeolite ZSM-12. The base can also include a beta zeolite.

Among other factors, it has been discovered that the use of the present catalyst base, which includes ZSM-12, realizes numerous advantages in a single hydrocracking unit. The catalyst system results in improved selectivity for desired middle distillate products, while also improving the cold flow properties of the products.

### BRIEF DESCRIPTION OF THE FIGURES OF THE DRAWING

FIG. 1 graphically depicts improvement in cold flow properties of mid-distillate when comparing performance of hydrocracking catalysts made with and without ZSM-12.

FIG. 2 graphically depicts improvements in cold flow properties of unconverted oil when comparing performance of hydrocracking catalysts made with and without ZSM-12.

### DESCRIPTION OF PREFERRED EMBODIMENTS

The present process relates to hydrocracking a hydrocarbon feed in a single stage. The process is designed to improve the selectivity at comparable conversion of middle distillate (380-530° F., 193° C.-277° C.), or even light distillate (300° F.-380° F., 149° C.-193° C.). The process is also designed to improve the cold flow properties of the distillates. The process employs a particular catalyst in a single stage hydrocracking process, with the catalyst comprising a base comprised of alumina, an amorphous silica-aluminate (ASA), a USY zeolite, optionally a beta zeolite, and a ZSM-12 zeolite. The base is impregnated with catalytic metals selected from Group 6 and Groups 8 through 10 of the Periodic Table, preferably Nickel (Ni) and Tungsten (W). The term “Periodic Table” refers to the version of IUPAC Periodic Table of the Elements dated June 22, 2007, and the numbering scheme for the Periodic Table Groups is as described in Chemical and Engineering News, 63(5), 27 (1985).

The base of the catalyst can comprise from about 0.1 to about 40 wt. % alumina base, based on the dry weight of the base, in another embodiment from about 5 to about 40 wt. %, or in another embodiment from about 20 to about 30 wt. % alumina. About 25 wt. % alumina can be used in another embodiment. The base of the catalyst can also comprise from about 30 to about 80 wt. % ASA, based on the dry weight of the base, or in another embodiment from about 45 to about 75 wt. % ASA. The Y zeolite can comprise from 0.5 to about 40 wt. % of the base based on the dry weight of the base. In another embodiment, the Y zeolite can comprise from about 1 to about 30 wt. %, or in another embodiment, from about 4 to about 20 wt. % of the base. The beta zeolite can be optional and can comprise from 0 to about 40 wt. % of the base based on the dry weight of the base, or from 0.5 to about 40 wt. %. In another embodiment, the beta zeolite can comprise from about 1 to about 30 wt. %, or in another embodiment, from about 4 to about 20 wt. % of the base. The ZSM-12 component of the base can comprise from about 0.1 to about 40 wt. % based on the dry weight of the base, or in another embodiment from about 0.5 to about 30 wt. %, or from about 2 to about 20 wt. % of the base. When beta zeolite is present, the amount of ZSM-12 can be reduced.

The alumina can be any alumina known for use in a catalyst base. For example, the alumina can be γ-alumina, η-alumina, θ-alumina, δ-alumina, χ-alumina, or a mixture thereof.

The ASA of the catalyst support is an amorphous silica-alumina material in which the mean mesopore diameter is generally between 70 Å and 130 Å.

In one embodiment, the amorphous silica-alumina material comprises SiO₂ in an amount of 5 to 70 wt. % of the bulk dry weight of the carrier as determined by ICP elemental analysis, a BET surface area of between 300 and 550 m²/g and a total pore volume of between 0.95 and 1.55 mL/g.

In another embodiment, the catalyst support comprises an amorphous silica-alumina material containing SiO₂ in an amount of 5 to 70 wt. % of the bulk dry weight of the carrier as determined by ICP elemental analysis, a BET surface area of between 300 and 550 m²/g, a total pore volume of between 0.95 and 1.55 mL/g, and a mean mesopore diameter is between 70 Å and 130 Å.

In another subembodiment, the catalyst support comprises a highly homogeneous amorphous silica-alumina material having a surface to bulk silica to alumina ratio (S/B ratio) of 0.7 to 1.3, and a crystalline alumina phase present in an amount no more than about 10 wt. %.

$$S / B Ratio = \frac{( Si / Al atomic ratio of the surface area measured by XPS )}{( ( Si / Al atomic ratio of the bulk measured by elemental analysis )}$$

To determine the S/B ratio, the Si/Al atomic ratio of the silica-alumina surface is measured using x-ray photoelectron spectroscopy (XPS). XPS is also known as electron spectroscopy for chemical analysis (ESCA). Since the penetration depth of XPS is less than 50 Å, the Si/Al atomic ratio measured by XPS is for the surface chemical composition.

Use of XPS for silica-alumina characterization was published by W. Daneiell et al. in Applied Catalysis A, 196, 247-260, 2000. The XPS technique is, therefore, effective in measuring the chemical composition of the outer layer of catalytic particle surface. Other surface measurement techniques, such as Auger electron spectroscopy (AES) and Secondary-ion mass spectroscopy (SIMS), could also be used for measurement of the surface composition.

Separately, the bulk Si/Al ratio of the composition is determined from ICP elemental analysis. Then, by comparing the surface Si/Al ratio to the bulk Si/Al ratio, the S/B ratio and the homogeneity of silica-alumina are determined. How the S/B ratio defines the homogeneity of a particle is explained as follows. An S/B ratio of 1.0 means the material is completely homogeneous throughout the particles. An S/B ratio of less than 1.0 means the particle surface is enriched with aluminum (or depleted with silicon), and aluminum is predominantly located on the external surface of the particles. The S/B ratio of more than 1.0 means the particle surface is enriched with silicon (or depleted with aluminum), and aluminum is predominantly located on the internal area of the particles.

“Zeolite USY” refers to ultra-stabilized Y zeolite. Y zeolites are synthetic faujasite (FAU) zeolites having a SAR (silica to alumina molar ratio) of 3 or higher. Y zeolite can be ultra-stabilized by one or more of hydrothermal stabilization, dealumination, and isomorphous substitution. Zeolite USY can be any FAU-type zeolite with a higher framework silicon content than a starting (as-synthesized) Na-Y zeolite precursor. Such suitable Y zeolites are commercially available from, e.g., Zeolyst, Tosoh, and JGC.

The beta zeolite beta refers to zeolites having a 3-dimensional crystal structure with straight 12-membered ring channels with crossed 12-membered ring channels, and having a framework density of about 15.3 T/1000 Å³. Zeolite beta has a BEA framework as described in Ch. Baerlocher and L. B. McCusker, Database of Zeolite Structures: http://www.iza-structure.org/databases/.

In one embodiment, the zeolite beta has an OD acidity of 20 to 400 μmol/g and an average domain size from 800 to 1500 nm². In one embodiment, the OD acidity is from 30 to 100 μmol/g.

In one embodiment the zeolite beta is synthetically manufactured using organic templates. Examples of three different zeolite betas are described in Table 1.

TABLE 1

| | SiO₂/Al₂O₃ Molar | OD Acidity |
|---|---|---|
| Zeolite Betas | Ratio (SAR) | (μmol/g) |
| H-BEA-35 | 35 | 304 |
| H-BEA-150 | 150 | 36 |
| H-BEA-300 | 300 | — |

The total OD acidity was determined by H/D exchange of acidic hydroxyl groups by FTIR spectroscopy. The method to determine the total OD acidity was adapted from the method described in the publication by Emiel J. M. Hensen et. al., J. Phys. Chem., C2010, 114, 8363-8374. Prior to FTIR measurement, the sample was heated for one hour at 400-450° C. under vacuum<1×10⁻⁵ Torr. Then the sample was dosed with C₆D₆ to equilibrium at 80° C. Before and after C₆D₆ dosing, spectra were collected for OH and OD stretching regions.

The average domain size was determined by a combination of transmission electron (TEM) and digital image analysis, as follows:

### I. Zeolite Beta Sample Preparation:

The zeolite beta sample was prepared by embedding a small amount of the zeolite beta in an epoxy and microtoming. The description of suitable procedures can be found in many standard microscopy textbooks.

Step 1. A small representative portion of the zeolite beta powder was embedded in epoxy. The epoxy was allowed to cure.

Step 2. The epoxy containing a representative portion of the zeolite beta powder was microtomed to 80-90 nm thick. The microtome sections were collected on a 400 mesh 3 mm copper grid, available from microscopy supply vendors.

Step 3. A sufficient layer of electrically-conducting carbon was vacuum evaporated onto the microtomed sections to prevent the zeolite beta sample from charging under the electron beam in the TEM.

### II. TEM Imaging:

Step 1. The prepared zeolite beta sample, described above, can be surveyed at low magnifications, e.g., 250,000-1,000,000× to select a crystal in which the zeolite beta channels can be viewed.

Step 2. The selected zeolite beta crystals were tilted onto their zone axis, focused to near Scherzer defocus, and an image was recorded ≥2,000,000×.

III. Image Analysis to Obtain Average Domain Size (nm2):

Step 1. The recorded TEM digital images described previously were analyzed using commercially available image analysis software packages.

Step 2. The individual domains were isolated and the domain sizes were measured in nm2. The domains where the projection was not clearly down the channel view were not included in the measurements.

Step 3. A statistically relevant number of domains were measured. The raw data was stored in a computer spreadsheet program.

Step 4. Descriptive statistics, and frequencies were determined—The arithmetic mean (dav), or average domain size, and the standard deviation (s) were calculated using the following equations:

The average domain size, dₐᵥ=(ånᵢdᵢ)/(ånᵢ)

The standard deviation, s=(å(dᵢ−dₐᵥ)²/(ånᵢ))^{1/2}

In one embodiment the average domain size is from 900 to 1250 nm², such as from 1000 to 1150 nm².

The last component of the catalyst base is a MTW zeolite, specifically known as ZSM-12. The ZSM-12 zeolite is a silica rich zeolite comprised of a one-dimensional 12 membered ring channel system with unique pore openings of 5.7 Angstroms to 6.1 Angstroms. The ZSM-12 zeolite is described in detail in U.S. Pat. Nos. 3,832,449 and 4,391,785, the disclosures of which are herein incorporated by reference in their entirety.

ZSM-12 can suitably be prepared by preparing a solution containing at least one cyclic quaternary amine halide, sodium oxide, an oxide of silica, and optionally, an oxide of alumina and water and having a composition in terms of mole ratios of oxides falling within the following ranges:

| | Broad | Preferred |
|---|---|---|
| OH⁻/SiO₂ | 0.1-0.40 | 0.15-0.25 |
| R/R + M+ | 0.2-0.95 | 0.28-0.90 |
| SiO₂/ Al₂O₃ | 40-∞ | 85-500 |
| H₂O/OH⁻ | 20-300 | 5-100 |

wherein R is dimethyl pyrrolidinium, dimethyl piperidinium, or dimethyl pyridinium halide, M is an alkali metal and maintaining the mixture until crystals of the zeolite are formed. Thereafter, the crystals are separated from the liquid and recovered. Typical reaction conditions consist of heating the reaction mixture to a temperature of from about 80° C. to 180° C. for a period of time ranging from about 6 hours to 150 days. A more preferred temperature range is from about 100° C. to about 150° C. for a period of time ranging from about 2 to 40 days.

ZSM-12 zeolites possess a definite distinguishing crystalline structure whose X-ray diffraction pattern shows the following significant lines:

| Interplanar Spacing D (A) | Relative Intensity |
|---|---|
| 11.9 ± 0.2 | M |
| 10.1 ± 0.2 | M |
| 4.76 ± 0.1 | W |
| 4.29 ± 0.08 | VS |
| 3.98 ± 0.08 | M |
| 3.87 ± 0.07 | VS |
| 3.49 ± 0.07 | W |
| 3.38 ± 0.07 | M |
| 3.20 ± 0.06 | W |
| 3.05 ± 0.05 | W |
| 2.54 0.03 | W |

These values were determined by standard techniques. The radiation was the K-alpha doublet of copper, and a scintillation counter spectrometer with a strip chart pen recorder was used. The peak heights, I, and the positions as a function of 2 times theta, where theta is the Bragg angle, were read from the spectrometer chart. From these, the relative intensities, 100 I/Iₒ, where Iₒ, is the intensity of the strongest line or peak, and d (obs.), the interplanar spacing in A, corresponding to the recorded lines, were calculated. In Table I the relative intensities are given in terms of the symbols m=medium, w=weak and vs=very strong. It should be understood that this X-ray diffraction pattern is characteristic of all the species of ZSM-12 compositions. Ion exchange of the sodium ion with cations reveals substantially the same pattern with some minor shifts in interplanar spacing and variation in relative intensity. Other minor variations can occur depending on the silicon to aluminum ratio of the particular sample, as well as if it has been subjected to thermal treatment.

ZSM-12 zeolites are commercially available from, e.g., Clariant, Zeolyst, China Catalyst Group.

As described herein above, the hydrocracking catalyst of the present single stage hydrocracking process contains one or more metals, which metals are impregnated into the above described base or support. For each embodiment described herein, each metal employed is selected from the group consisting of elements from Group 6 and Groups 8 through 10 of the Periodic Table, and mixtures thereof. In one embodiment, each metal is selected from the group consisting of nickel (Ni), palladium (Pd), platinum (Pt), cobalt (Co), iron (Fe), chromium (Cr), molybdenum (Mo), tungsten (W), and mixtures thereof. In another embodiment, the hydrocracking catalyst contains at least one Group 6 metal and at least one metal selected from Groups 8 through 10 of the periodic table. Exemplary metal combinations include Ni/Mo/W, Ni/Mo, Ni/W, Co/Mo, Co/W, Co/W/Mo and Ni/Co/W/Mo.

The total amount of metal material in the hydrocracking catalyst is from 0.1 wt. % to 90 wt. % based on the bulk dry weight of the hydrocracking catalyst. In one embodiment, the hydrocracking catalyst contains from 2 wt. % to 10 wt. % of nickel material and from 8 wt. % to 40 wt. % of tungsten material based on the bulk dry weight of the hydrocracking catalyst.

A diluent may be employed in the formation of the hydrocracking catalyst. Suitable diluents include inorganic oxides such as aluminum oxide and silicon oxide, titanium oxide, clays, ceria, and zirconia, and mixture of thereof. The amount of diluent in the hydrocracking catalyst is from 0 wt. % to 35 wt. % based on the bulk dry weight of the hydrocracking catalyst. In one embodiment, the amount of diluent in the hydrocracking catalyst is from 0.1 wt. % to 25 wt. % based on the bulk dry weight of the hydrocracking catalyst.

The hydrocracking catalyst of the present process can also contain one or more promoters selected from the group consisting of phosphorous (P), boron (B), fluorine (F), silicon (Si), aluminum (Al), zinc (Zn), manganese (Mn), and mixtures thereof. The amount of promoter in the hydrocracking catalyst is from 0 wt. % to 10 wt. % based on the bulk dry weight of the hydrocracking catalyst. In one embodiment, the amount of promoter in the hydrocracking catalyst is from 0.1 wt. % to 5 wt. % based on the bulk dry weight of the hydrocracking catalyst.

### Preparation of the Hydrocracking Catalyst

In one embodiment, metal deposition is achieved by contacting at least the catalyst support with an impregnation solution. The impregnation solution contains at least one metal salt such as a metal nitrate or metal carbonate, solvent and has a pH between 1 and 5.5, inclusive (1≤pH≤5.5). In one embodiment, the impregnation solution further contains a modifying agent described herein below. In one embodiment, a shaped hydrocracking catalyst is prepared by:

(a) forming an extrudable mass containing the catalyst base comprised of alumina, an amorphous silica alumina (ASA), a USY zeolite, a ZSM-12 zeolite, and optionally a beta zeolite,

(b) extruding the mass to form a shaped extrudate,

(c) calcining the mass to form a calcined extrudate,

(d) contacting the shaped extrudate with an impregnation solution containing at least one metal salt, solvent, and having a pH between 1 and 5.5, inclusive (1≤pH≤5.5), and

(e) drying the impregnated extrudate at a temperature sufficient to remove the impregnation solution solvent to form a dried impregnated extrudate.

In another embodiment, a shaped hydrocracking catalyst is prepared by:

(a) forming an extrudable mass containing the catalyst base comprised of alumina, an amorphous silica alumina (ASA), a USY zeolite, a ZSM-12 zeolite, and optionally a beta zeolite,

(b) extruding the mass to form a shaped extrudate,

(c) calcining the mass to form a calcined extrudate,

(d) contacting the shaped extrudate with an impregnation solution containing at least one metal salt, solvent, and a modifying agent, wherein the impregnation solution has a pH between 1 and 5.5, inclusive (1≤pH≤5.5), and

(e) drying the impregnated extrudate at a temperature below the decomposition temperature of the modifying agent but sufficient to remove the impregnation solution solvent and form a dried impregnated extrudate.

In another embodiment, a shaped hydrocracking catalyst is prepared by:

(a) forming an extrudable mass containing the catalyst base comprised of alumina, an amorphous silica alumina (ASA), a USY zeolite, a ZSM-12 zeolite, and optionally a beta zeolite,

(b) extruding the mass to form a shaped extrudate,

(c) calcining the mass to form a calcined extrudate,

(d) contacting the shaped extrudate with an impregnation solution containing at least one metal salt, solvent, and a modifying agent, wherein the impregnation solution has a pH between 1 and 5.5, inclusive (1≤pH≤5.5),

(e) drying the impregnated extrudate at a temperature below the decomposition temperature of the modifying agent but sufficient to remove the impregnation solution solvent and form a dried impregnated extrudate, and

(f) calcining the dried impregnated extrudate sufficiently to remove the modifying agent and convert at least one metal into oxide.

In one embodiment, a mild acid is used in forming the extrudable mass containing the catalyst base. For example, in one embodiment a diluted HNO₃ acid aqueous solution from 0.5 to 5 wt. % HNO₃ is used.

In one embodiment, the impregnation solution comprises a metal carbonate and a modifying agent. Nickel carbonate in the preferred metal carbonate for use in the preparation of the present catalyst.

The diluent, promoter and/or molecular sieve (if employed) may be combined with the carrier when forming the extrudable mass. In another embodiment, the carrier and (optionally) the diluent, promoter and/or molecular sieve can be impregnated before or after being formed into the desired shapes.

For each embodiment described herein, the impregnation solution has a pH between 1 and 5.5, inclusive (1≤pH≤5.5). In one subembodiment, the impregnation solution has a pH between 1.5 and 3.5, inclusive (1.5≤pH≤3.5).

Depending on the metal nitrates and other components used to form the impregnation solution, before the addition of a basic component the pH of the impregnation solution will typically have a pH of less than 1, and more typically a pH of about 0.5. By adding a basic component to the impregnation solution to affect a pH adjustment to 1 and 5.5, inclusive (1≤pH≤5.5), the acid concentration is eliminated or reduced to a level which, during calcination, does not acid-catalyze decomposition of the ammonium nitrate at a rate rapid enough to have a deleterious effect on the hydrocracking catalyst. In one embodiment, the acid concentration is eliminated or reduced to a level which, during calcination, does not acid-catalyze decomposition of the ammonium nitrate at a rate rapid enough to have a deleterious effect on more than 10 wt. % of the bulk dry weight of the hydrocracking catalyst (e.g., does not produce fines or fractured extrudates which account for more than 10 wt. % of the bulk dry weight of the post-calcined hydrocracking catalyst).

The basic component can be any base which can dissolve in the solvent selected for the impregnation solution and which is not substantially deleterious to the formation of the catalyst or to the hydrocracking performance of the catalyst, meaning that the base has less than a measurable effect on, or confer less than a material disadvantage to, the performance of the hydrocracking catalyst. A base which is not substantially deleterious to the formation of the catalyst will not reduce catalyst activity by more than 10° F. (5.5° C.) based on the performance of the hydrocracking catalyst without pH correction.

Where the hydrocracking catalyst is to be used in the present hydrocracking process, one suitable base is ammonium hydroxide. Other exemplary bases include potassium hydroxide, sodium hydroxide, calcium hydroxide, and magnesium hydroxide.

In one embodiment, deposition of at least one of the metals is achieved in the presence of a modifying agent selected from the group consisting of compounds represented by structures (1) through (4), including condensated forms thereof:

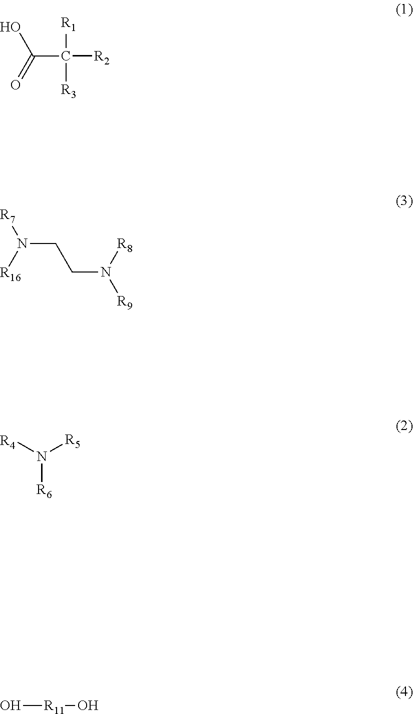

wherein:

(1) R₁, R₂ and R₃ are independently selected from the group consisting of hydrogen; hydroxyl; methyl; amine; and linear or branched, substituted or unsubstituted C₁-C₃ alkyl groups, C₁-C₃ alkenyl groups, C₁-C₃ hydroxyalkyl groups, C₁-C₃ alkoxyalkyl groups, C₁-C₃ aminoalkyl groups, C₁-C₃ oxoalkyl groups, C₁-C₃ carboxyalkyl groups, C₁-C₃ aminocarboxyalkyl groups and C₁-C₃ hydroxycarboxyalkyl groups;

(2) R₄ through R₁₀ are independently selected from the group consisting of hydrogen; hydroxyl; and linear or branched, substituted or unsubstituted C₂-C₃ carboxyalkyl groups; and

(3) R₁₁ is selected from the group consisting of linear or branched, saturated and unsaturated, substituted or unsubstituted C₁-C₃ alkyl groups, C₁-C₃ hydroxyalkyl groups, and C₁-C₃ oxoalkyl groups.

Representative examples of modifying agents useful in this embodiment include 2,3-dihydroxy-succinic acid, ethanedioic acid, 2-hydroxyacetic acid, 2-hydroxy-propanoic acid, 2-hydroxypropane-1,2,3-tricarboxylic acid, methoxyacetic acid, cis-1,2-ethylene dicarboxylic acid, hydroethane-1,2-dicarboxylic acid, ethane-1,2-diol, propane-1,2,3-triol, propanedioic acid, and α-hydro-ω-hydroxypoly(oxyethylene).

In one embodiment, the modifying agent used is 2-hydroxypropane-1,2,3-tricarboxylic acid (citric acid). Such a modifying agent provides excellent results, is economic and readily available.

In an alternate embodiment, deposition of at least one of the metals is achieved in the presence of a modifying agent selected from the group consisting of N,N′-bis(2-aminoethyl)-1,2-ethane-diamine, 2-amino-3-(1H-indol-3-yl)-propanoic acid, benzaldehyde, [[(carboxymethyl)imino]bis(ethylenenitrilo)]-tetra-acetic acid, 1,2-cyclohexanediamine, 2-hydroxybenzoic acid, thiocyanate, thiosulfate, thiourea, pyridine, and quinoline.

The modifying agent impedes metal aggregation, thereby enhancing the activity and selectivity of the catalyst.

For each embodiment described herein, when employed, the amount of modifying agent in the pre-calcined hydrocracking catalyst is from 2 wt. % to 18 wt. % based on the bulk dry weight of the hydrocracking catalyst.

The calcination of the extruded mass can vary. Typically, the extruded mass can be calcined at a temperature between 752° F. (400° C.) and 1200° F. (650° C.) for a period of between 1 and 3 hours.

Non-limiting examples of suitable solvents include water and C₁ to C₃ alcohols. Other suitable solvents can include polar solvents such as alcohols, ethers, and amines. Water is a preferred solvent. It is also preferred that the metal compounds be water soluble and that a solution of each be formed, or a single solution containing both metals be formed. The modifying agent can be prepared in a suitable solvent, preferably water.

The three solvent components can be mixed in any sequence. That is, all three can be blended together at the same time, or they can be sequentially mixed in any order. In an embodiment, it is preferred to first mix the one or more metal components in an aqueous media, than add the modifying agent.

The amount of metal precursors and modifying agent (when employed) in the impregnation solution should be selected to achieve preferred ratios of metal to modifying agent in the catalyst precursor after drying.

The calcined extrudate is exposed to the impregnation solution until incipient wetness is achieved, typically for a period of between 0.1 and 100 hours (more typically between 1 and 5 hours) at room temperature to 212° F. (100° C.) while tumbling the extrudates, following by aging for from 0.1 to 10 hours, typically from about 0.5 to about 5 hours.

The drying step is conducted at a temperature sufficient to remove the impregnation solution solvent, but below the decomposition temperature of the modifying agent. In another embodiment, the dried impregnated extrudate is then calcined at a temperature above the decomposition temperature of the modifying agent, typically from about 500° F. (260° C.) to 1100° F. (590° C.), for an effective amount of time. The present invention contemplates that when the impregnated extrudate is to be calcined, it will undergo drying during the period where the temperature is being elevated or ramped to the intended calcination temperature. This effective amount of time will range from about 0.5 to about 24 hours, typically from about 1 to about 5 hours. The calcination can be carried out in the presence of a flowing oxygen-containing gas such as air, a flowing inert gas such as nitrogen, or a combination of oxygen-containing and inert gases.

In one embodiment, the impregnated extrudate is calcined at a temperature which does not convert the metals to metal oxides. Yet in another embodiment, the impregnated extrudates can be calcined at a temperature sufficient to convert the metals to metal oxides.

The dried and calcined hydrocracking catalysts of the present invention can be sulfided to form an active catalyst. Sulfiding of the catalyst precursor to form the catalyst can be performed prior to introduction of the catalyst into a reactor (thus ex-situ presulfiding), or can be carried out in the reactor (in-situ sulfiding).

Suitable sulfiding agents include elemental sulfur, ammonium sulfide, ammonium polysulfide ([(NH₄)₂Sₓ), ammonium thiosulfate ((NH₄)₂S₂O₃), sodium thiosulfate (Na₂S₂O₃), thiourea CSN₂H₄, carbon disulfide, dimethyl disulfide (DMDS), dimethyl sulfide (DMS), dibutyl polysulfide (DBPS), mercaptanes, tertiarybutyl polysulfide (PSTB), tertiarynonyl polysulfide (PSTN), aqueous ammonium sulfide.

Generally, the sulfiding agent is present in an amount in excess of the stoichiometric amount required to form the sulfided catalyst. In another embodiment, the amount of sulfiding agent represents a sulphur to metal mole ratio of at least 3 to 1 to produce a sulfided catalyst.

The catalyst is converted into an active sulfided catalyst upon contact with the sulfiding agent at a temperature of 150° F. to 900° F. (66° C. to 482° C.), from 10 minutes to 15 days, and under a H₂-containing gas pressure of 101 kPa to 25,000 kPa. If the sulfidation temperature is below the boiling point of the sulfiding agent, the process is generally carried out at atmospheric pressure. Above the boiling temperature of the sulfiding agent/optional components, the reaction is generally carried out at an increased pressure. As used herein, completion of the sulfidation process means that at least 95% of stoichiometric sulfur quantity necessary to convert the metals into for example, CO₉S₈, MoS₂, WS₂, Ni₃S₂, etc., has been consumed.

In one embodiment, the sulfiding can be carried out to completion in the gaseous phase with hydrogen and a sulfur-containing compound which is decomposable into H₂S. Examples include mercaptanes, CS₂, thiophenes, DMS, DMDS and suitable S-containing refinery outlet gasses. The gaseous mixture of H₂ and sulfur containing compound can be the same or different in the steps. The sulfidation in the gaseous phase can be done in any suitable manner, including a fixed bed process and a moving bed process (in which the catalyst moves relative to the reactor, e.g., ebullated process and rotary furnace).

The contacting between the catalyst precursor with hydrogen and a sulfur-containing compound can be done in one step at a temperature of 68° F. to 700° F. (20° C. to 371° C.) at a pressure of 101 kPa to 25,000 kPa for a period of 1 to 100 hrs. Typically, sulfidation is carried out over a period of time with the temperature being increased or ramped in increments and held over a period of time until completion.

In another embodiment of sulfidation, it can occur in the gaseous phase. The sulfidation is done in two or more steps, with the first step being at a lower temperature than the subsequent step(s).

In one embodiment, the sulfidation is carried out in the liquid phase. At first, the catalyst precursor is brought in contact with an organic liquid in an amount in the range of 20% to 500% of the catalyst total pore volume. The contacting with the organic liquid can be at a temperature ranging from ambient to 248° F. (120° C.). After the incorporation of an organic liquid, the catalyst precursor is brought into contact with hydrogen and a sulfur-containing compound.

In one embodiment, the organic liquid has a boiling range of 200° F. to 1200° F. (93° C. to 649° C.). Exemplary organic liquids include petroleum fractions such as heavy oils, lubricating oil fractions like mineral lube oil, atmospheric gas oils, vacuum gas oils, straight run gas oils, white spirit, middle distillates like diesel, jet fuel and heating oil, naphtha, and gasoline. In one embodiment, the organic liquid contains less than 10 wt. % sulfur, and preferably less than 5 wt. %.

The present process is a single stage hydrocracking process. The feed to a single stage hydrocracker has credible concentrations of nitrogen and sulfur, often as ammonia and hydrogen sulfide. Thus, the catalyst must endure such a dirty feed as the presence of the nitrogen and sulfur can impact reaction rates, thereby leading to different product selectivity and catalyst activity.

The present single stage hydrocracking process comprises contacting a hydrocarbon feedstock with the present catalyst under hydrocarbon conditions to produce an effluent that comprises middle distillates in a single stage. In one embodiment, the catalyst is employed in one or more fixed beds in a single stage hydrocracking unit, with recycle or without recycle (once through). Optionally, the single-stage hydrocracking unit may employ multiple single-stage units operated in parallel.

Suitable hydrocarbon feedstocks include visbroken gas oils (VGB), heavy coker gas oils, gas oils derived from residue hydrocracking or residue desulfurization. Other thermally cracked oils, deasphalted oils, Fischer-Trapsch derived feedstocks, cycle oils from an FCC unit, heavy coal-derived distillates, coal gasification byproduct tars, heavy shale-derived oils, organic waste oils such as those from pulp or paper mills or from waste biomass pyrolysis units.

The hydrocracking conditions include a temperature in the range of from 175° C. to 485° C., molar ratios of hydrogen to hydrocarbon charge from 1 to 100, a pressure in the range of from 0.5 to 350 bar, and a liquid hourly space velocity (LHSV) in the range of from 0.1 to 30. By using the present catalyst base, including ZSM-12, in a single stage hydrocracking process, it has been found that an improvement in selectivity (at a comparable conversion) of more desirable middle distillate (380-530° F.) products are observed. For middle distillate products the selectivity can be at least 20 wt. %. In other embodiments, a selectivity to middle distillate products of at least 25 wt. %, at least 28 wt. %, or even at least 30 wt. % can be realized. Light distillate can also show an increase. A beneficial improvement in cold flow properties of middle distillates is also observed.

### EXAMPLE 1

The support and catalyst compositions and characteristics of Samples A, B, C and D are shown in Table 2:

TABLE 2

| | Catalyst ID | | | |
|---|---|---|---|---|
| Base | Sample A | Sample B | Sample C | Sample D |
| USY, wt % | 22.4 | 16.6 | 16 | 16 |
| Beta, wt % | 5.6 | 8.3 | 8 | 0 |
| ZSM-12, wt % | 0 | 0 | 4 | 12 |
| Alumina, wt % | 22.6 | 22.6 | 22.6 | 22.6 |
| ASA, wt % | 49.4 | 52.5 | 49.4 | 49.4 |
| Particle density, g/mL | 0.83 | 0.85 | 0.87 | 0.87 |

Porosity by N₂ uptake

| | | | | |
|---|---|---|---|---|
| Surface area, m²/g | 503 | 472 | 458 | 466 |
| Mean mesopore | 102 | 90 | 97 | 95 |
| diameter, Å | | | | |
| Total Pore volume, mL/g | 0.886 | 0.818 | 0.808 | 0.836 |

Finished Catalyst

| | | | | |
|---|---|---|---|---|
| Metal content, wt % | | | | |
| Nickel oxide (NiO) | 3.8 | 3.8 | 3.8 | 3.8 |
| Tungsten oxide (WO₃) | 32 | 32 | 32 | 32 |
| Particle density, g/mL | 1.36 | 1.38 | 1.39 | 1.41 |

Porosity by N₂ uptake

| | | | | |
|---|---|---|---|---|
| Surface area, m²/g | 265 | 291 | 258 | 251 |
| Mean mesopore | 102 | 91 | 99 | 99 |
| diameter, Å | | | | |
| Total Pore volume, mL/g | 0.417 | 0.463 | 0.397 | 0.402 |

### EXAMPLE 2

### Catalyst (Sample) A—Comparative Hydrocracking Catalyst

A comparative hydrocracking catalyst was prepared per the following procedure: 49.4 parts by weight silica-alumina powder (obtained from Sasol), 22.6 parts by weight pseudo boehmite alumina powder (obtained from Sasol), 22.4 parts by weight of zeolite Y (from Zeolyst, JGC, Tosoh), and 5.6 parts by weight of zeolite beta (from Clariant, Zeolyst, China Catalyst Group, BASF) were mixed well. A diluted HNO₃ acid aqueous solution (2 wt. %) was added to the mix powder to form an extrudable paste. The paste was extruded in 1/16″ asymmetric quadrilobe shape, and dried at 250° F. (121° C.) overnight. The dried extrudates were calcined at 1100° F. (593° C.) for 1 hour with purging excess dry air, and cooled down to room temperature.

Impregnation of Ni and W was done using a solution containing ammonium metatungstate and nickel carbonate basic hydrate to the target metal loadings of 3.8 wt. % NiO and 32.0 wt. % WO₃ in bulk dry weight of the finished catalyst. A chelating agent, citric acid (with acid/Ni molar ratio of 0.79), was mixed with nickel carbonate basic hydrate along with DI water initially. The nickel/acid solution was then heated to 149° F. (65° C.) or above in a water bath for the decomposition of carbonate before adding ammonium metatungstate to the solution. The total volume of the solution matched the 103% water pore volume of the base extrudate sample (incipient wetness method). The metal solution was added to the base extrudates gradually while tumbling the extrudates. When the solution addition was completed, the soaked extrudates were aged for 2 hours. Then the extrudates were dried at 250° F. (121° C.) for 2 hours. The dried extrudates were calcined at 425° F. (218° C.) for 1 hour with purging excess dry air, and cooled down to room temperature. This catalyst is named Catalyst A and its physical properties are summarized in Table 2 above.

### EXAMPLE 3

### Catalyst (Sample) B—A Second Comparative Hydrocracking Catalyst

A comparative hydrocracking catalyst was prepared per the following procedure: 52.5 parts by weight silica-alumina powder, 22.6 parts by weight pseudo boehmite alumina powder, 16.6 parts by weight of zeolite Y, and 8.3 parts by weight of zeolite beta were mixed well. A diluted HNO₃ acid aqueous solution (2 wt. %) was added to the mix powder to form an extrudable paste. The paste was extruded in 1/16″ asymmetric quadrilobe shape, and dried at 250° F. (121° C.) overnight. The dried extrudates were calcined at 1100° F. (593° C.) for 1 hour with purging excess dry air, and cooled down to room temperature.

Impregnation of Ni and W was done using a solution containing ammonium metatungstate and nickel carbonate basic hydrate to the target metal loadings of 3.8 wt. % NiO and 32.0 wt. % WO₃ in bulk dry weight of the finished catalyst. A chelating agent, citric acid (with acid/Ni molar ratio of 0.79), was mixed with nickel carbonate basic hydrate along with DI water initially. The nickel/acid solution was then heated to 149° F. (65° C.) or above in a water bath for the decomposition of carbonate before adding ammonium metatungstate to the solution. The total volume of the solution matched the 103% water pore volume of the base extrudate sample (incipient wetness method). The metal solution was added to the base extrudates gradually while tumbling the extrudates. When the solution addition was completed, the soaked extrudates were aged for 2 hours. Then the extrudates were dried at 250° F. (121° C.) for 2 hours. The dried extrudates were calcined at 425° F. (218° C.) for 1 hour with purging excess dry air, and cooled down to room temperature. This catalyst is named Catalyst B and its physical properties are summarized in Table 2 above.

### EXAMPLE 4

### Catalyst (Sample) C—A New Hydrocracking Catalyst with ZSM-12 Zeolite

A hydrocracking catalyst in accordance with the following process was prepared per the following procedure: 49.4 parts by weight silica-alumina powder, 22.6 parts by weight pseudo boehmite alumina powder, 16.0 parts by weight of zeolite Y, 8.0 parts by weight of zeolite beta, and 4.0 parts by weight of zeolite ZSM-12 were mixed well. A diluted HNO3 acid aqueous solution (2 wt. %) was added to the mix powder to form an extrudable paste. The paste was extruded in 1/16″ asymmetric quadrilobe shape, and dried at 250° F. (121° C.) overnight. The dried extrudates were calcined at 1100° F. (593° C.) for 1 hour with purging excess dry air, and cooled own to room temperature.

Impregnation of Ni and W was done using a solution containing ammonium metatungstate and nickel nitrate basic hydrate to the target metal loadings of 3.8 wt. % NiO and 32.0 wt. % WO₃ in bulk dry weight of the finished catalyst. A chelating agent, citric acid (with acid/Ni molar ratio of 0.79), was mixed with nickel carbonate basic hydrate along with DI water initially. The nickel/acid solution was then heated to 149° F. (65° C.) in a water bath for the decomposition of carbonate before adding ammonium metatungstate to the solution. The total volume of the solution matched the 103% water pore volume of the base extrudate sample (incipient wetness method). The metal solution was added to the base extrudates gradually while tumbling the extrudates. When the solution addition was completed, the soaked extrudates were aged for 5 hours. Then the extrudates were dried at 150° F. (66° C.) for 1 hour and then at 250° F. (121° C.) for 1 hour. The dried extrudates were calcined at 425° F. (218° C.) for 1 hour with purging excess dry air, and cooled down to room temperature. This catalyst is named Catalyst C and its physical properties are summarized in Table 2 above.

### EXAMPLE 5

### Catalyst (Sample) D—A Second New Hydrocracking Catalyst with ZSM-12 Zeolite

A new hydrocracking catalyst was prepared per the following procedure: 49.4 parts by weight silica-alumina powder, 22.6 parts by weight pseudo boehmite alumina powder, 16.0 parts by weight of zeolite Y, and 12.0 parts by weight of zeolite ZSM-12 were mixed well. A diluted HNO₃ acid aqueous solution (2 wt. %) was added to the mix powder to form an extrudable paste. The paste was extruded in 1/16″ asymmetric quadrilobe shape, and dried at 250° F. (121° C.) overnight. The dried extrudates were calcined at 1100° F. (593° C.) for 1 hour with purging excess dry air, and cooled down to room temperature.

Impregnation of Ni and W was done using a solution containing ammonium metatungstate and nickel carbonate basic hydrate to the target metal loadings of 3.8 wt. % NiO and 32.0 wt. % WO₃ in bulk dry weight of the finished catalyst. A chelating agent, citric acid (with acid/Ni molar ratio of 0.79), was mixed with nickel carbonate basic hydrate along with DI water initially. The nickel/acid solution was then heated to 149° F. (65° C.) or above in a water bath for the decomposition of carbonate before adding ammonium metatungstate to the solution. The total volume of the solution matched the 103% water pore volume of the base extrudate sample (incipient wetness method). The metal solution was added to the base extrudates gradually while tumbling the extrudates. When the solution addition was completed, the soaked extrudates were aged for 5 hours. Then the extrudates were dried at 150° F. (66° C.) for 1 hour and then at 250° F. (121° C.) for 1 hour. The dried extrudates were calcined at 425° F. (218° C.) for 1 hour with purging excess dry air, and cooled down to room temperature. This catalyst is named Catalyst D and its physical properties are summarized in Table 2 above.

TABLE 3
VGO feed used for hydrocracking catalyst performance evaluation

| | |
|---|---|
| API | 21.7 |
| Nitrogen, ppm | 997 |
| Sulfur, wt. % | 2.21 |
| PCI by UV | 2284 |
| MCRT, wt % | 0.32 |
| Asphaltenes, ppm | 137 |
| Hydrogen by NMR, wt % | 12.27 |
| Hydrocarbon type by MS, Vol % | |
| Paraffins | 14.9 |
| Naphthenes | 29.0 |
| Aromatics | 35.3 |
| Sulfur compounds | 20.0 |
| SimDist. wt %, ° F. | |
| 0.5 | 626 |
| 5 | 689 |
| 10 | 723 |
| 15 | 745 |
| 20 | 762 |
| 30 | 792 |
| 40 | 818 |
| 50 | 842 |
| 60 | 869 |
| 70 | 896 |
| 80 | 930 |
| 90 | 974 |
| 95 | 1010 |
| 99.5 | 1089 |

### EXAMPLE 6

The various catalysts in Example 1 were used in hydrocracking the VGO feed given in Table 3 under similar conditions. All catalyst extrudates were shortened to an L/D of 1-2, and packed in ⅜″ OD Stainless Steel reactors. A total catalyst volume of 16.0 mL was loaded into two reactors in bench-scale units (BSUs). ICR 511 of 8.0 mL was loaded in the first reactor as hydrocracking pretreat for hydrodenitrogenation, hydrodesulfurization and hydro-dearomatization. ICR 511 was operated at a temperature of 710-725° F. (373-385° C.) to generate whole liquid product (WLP) with a nitrogen content in the range of 5 to 50 ppm. Hydrocracking catalysts of 8 mL prepared in Example 1 was loaded in the second reactor and was operated at a temperature in a range of 710-780° F. (373-416° C.) to reach hydrocracking conversion (<700° F. or <371° C.) between 20 wt % to 90 wt %.

Selected hydrocracking performance results are shown below in Table 4:

TABLE 4

| | Catalyst | | | |
|---|---|---|---|---|
| | Sample A | Sample B | Sample C | Sample D |
| Apparent Conversion | 58.69 | 57.13 | 59.64 | 60.66 |
| (<700° F.), wt. % | | | | |
| Hydrotreating CAT, ° F. | 715 | 715 | 715 | 710 |
| T at Conv., ° F. | 720 | 720 | 720 | 734 |
| LHSV of hydrotreating, | 2 | 2 | 2 | 2 |
| h⁻¹ | | | | |
| LHSV of HCR, h⁻¹ | 2 | 2 | 2 | 2 |
| Total pressure, psig | 2300 | 2300 | 2300 | 2300 |
| H2 partial pressure, psia | 2200 | 2201 | 2200 | 2197 |
| Gas rate, scf/bbl | 5850 | 5921 | 5871 | 5977 |
| Selectivity, wt. % | | | | |
| C₄_{^{−}} | 3.42 | 3.75 | 3.55 | 3.40 |
| C₅-180° F. | 7.74 | 8.38 | 6.94 | 7.53 |
| 180-300° F. | 15.74 | 15.33 | 15.69 | 16.58 |
| 300-380° F. | 12.90 | 11.73 | 12.01 | 13.53 |
| 380-530° F. | 27.88 | 26.92 | 28.19 | 28.03 |
| 530-700° F. | 31.59 | 33.12 | 32.95 | 30.20 |

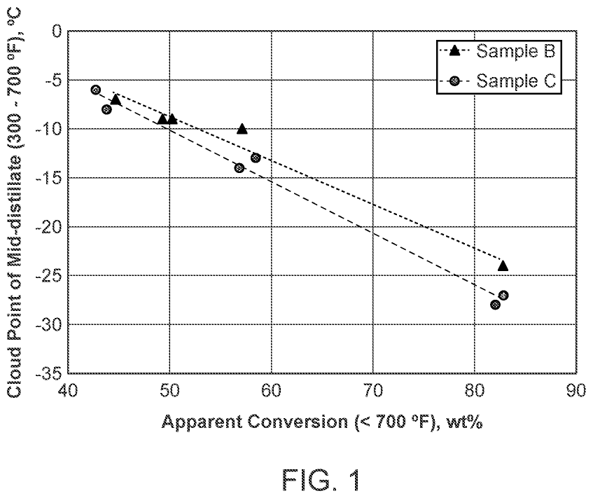

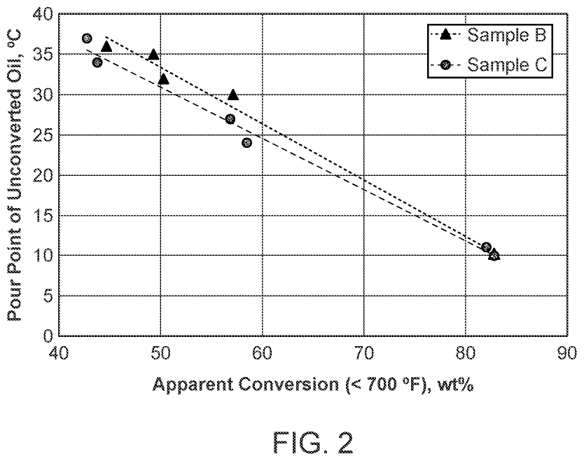

As can be seen from the foregoing results in Table 4, Samples C and D, present catalysts used in the present process, provide a significant improvement, at comparable conversion, in the middle distillate products (380-530° F., 193° C.-277° C.). An improvement in light distillates (300-380° F.) can also be seen. FIG. 1 and FIG. 2 compare the cold flow properties achieved when using Sample B and Sample C. Sample C demonstrates products with improved cloud point and pour point characteristics.

What is claimed is:

1. A hydrocracking process comprising:
passing a hydrocarbon feed to a single stage hydrocracking unit where the feed is hydrocracked under hydrocracking conditions, and with the catalyst in the hydrocracking unit comprising a base comprised of alumina, an amorphous silica-alumina material, a USY zeolite, ZSM-12, and a beta zeolite.

2. The process of claim 1, wherein the base comprises 5 to 40 wt. % alumina, 30 to 80 wt. % ASA, 0.5 to 40 wt. % USY zeolite, 0.1 to 40 wt. % ZSM-12, and 0 to 40 wt. % beta zeolite.

3. The process of claim 2, wherein the amount of alumina ranges from about 20 to about 30 wt. %.

4. The process of claim 2, wherein the amount of ASA ranges from about 45 to about 75 wt. %.

5. The process of claim 2, wherein the amount of USY zeolite ranges from about 4 to about 20 wt. %.

6. The process of claim 2, wherein the amount of beta zeolite ranges from about 4 to 20 wt. %.

7. The process of claim 2, wherein the amount of ZSM-12 ranges from about 2 to about 20 wt. %.

8. The process of claim 1, wherein the feed comprises a VGO.

9. The process of claim 1, wherein the selectivity of middle distillate (380-530° F.) is at least 28 wt. % at about 60 wt. % apparent conversion (<700° F.).

10. The process of claim 1, wherein the catalyst comprises the metals nickel (Ni) and tungsten (W) impregnated into the base.

11. The process of claim 10, wherein the catalyst comprises from about 2 to about 10 wt. % of nickel material and from about 8 to about 40 wt. % of tungsten material based on the bulk dry weight of the hydrocracking catalyst.

12. The process of claim 1, wherein the catalyst comprises a modifying agent.

13. The process of claim 12, wherein the modifying agent is selected from the group consisting of compounds represented by structures (1) through (4), and condensated forms thereof: 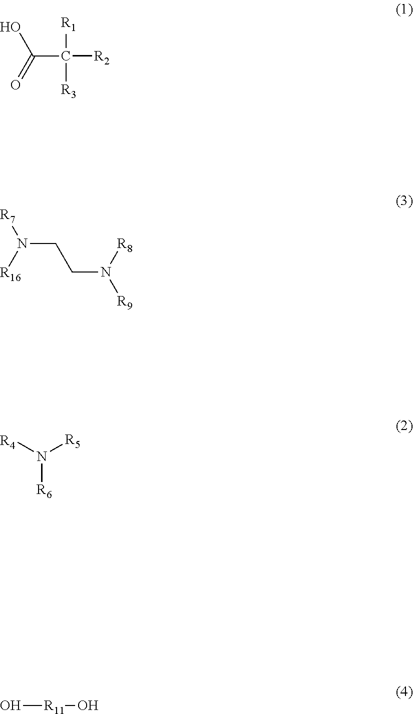
wherein:
(1) R₁, R₂ and R₃ are independently selected from the group consisting of hydrogen; hydroxyl; methyl; amine; and linear or branched, substituted or unsubstituted C₁-C₃ alkyl groups, C₁-C₃ alkenyl groups, C₁-C₃ hydroxyalkyl groups, C₁-C₃ alkoxyalkyl groups, C₁-C₃ aminoalkyl groups, C₁-C₃oxoalkyl groups, C₁-C₃ carboxyalkyl groups, C₁-C₃ aminocarboxyalkyl groups and C₁-C₃ hydroxycarboxyalkyl groups;
(2) R₄ through R₁₀ are independently selected from the group consisting of hydrogen; hydroxyl; and linear or branched, substituted or unsubstituted C₂-C₃ carboxyalkyl groups; and
(3) R₁₁ is selected from the group consisting of linear or branched, saturated and unsaturated, substituted or unsubstituted C₁-C₃ alkyl groups, C₁-C₃ hydroxyalkyl groups, and C₁-C₃ oxoalkyl groups.

14. The process of claim 13, wherein the modifying agent comprises citric acid.

15. The process of claim 1, wherein the catalyst in the hydrocracking unit is prepared by:
(a) forming an extrudable mass containing the catalyst base;
(b) extruding the mass to form a shaped extrudate;
(c) calcining the mass to form a calcined extrudate;
(d) preparing an impregnation solution containing at least one metal nitrate or metal carbonate, a solvent, a modifying agent and an ammonium containing component, and adjusting the pH of the impregnation solution to between 1 and 5.5 with a hydroxide base, inclusive;
(e) contacting the shaped extrudate with the impregnation solution; and
(f) drying the impregnated extrudate at a temperature sufficient to remove the impregnation solution solvent, to form a dried impregnated extrudate.

16. The process of claim 15, wherein the impregnation solution comprises nickel carbonate.

17. The process of claim 15, wherein the modifying agent k selected from the group consisting of compounds represented by structures (1) through (4), and condensated forms thereof: 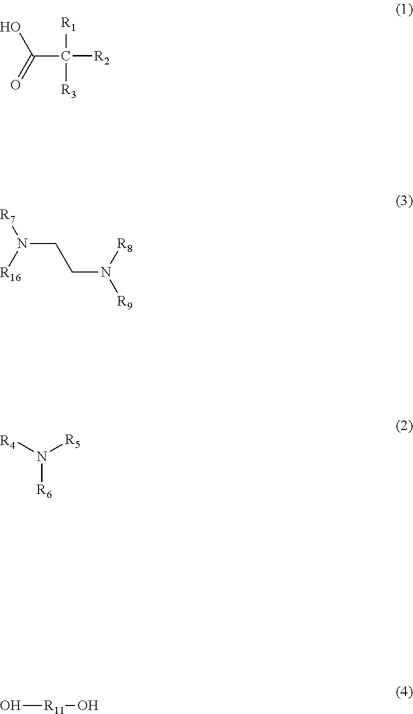
wherein:
(1) R₁, R₂ and R₃ are independently selected from the group consisting of hydrogen; hydroxyl; methyl; amine; and linear or branched, substituted or unsubstituted C₁-C₃ alkyl groups, C₁-C₃ alkenyl groups, C₁-C₃ hydroxyalkyl groups, C₁-C₃ alkoxyalkyl groups, C₁-C₃ aminoalkyl groups, C₁-C₃ oxoalkyl groups, C₁-C₃ carboxyalkyl groups, C₁-C₃ aminocarboxyalkyl groups and C₁-C₃ hydroxycarboxyalkyl groups;
(2) R₄ through R₁₀ are independently selected from the group consisting of hydrogen; hydroxyl; and linear or branched, substituted or unsubstituted C₂-C₃ carboxyalkyl groups; and
(3) R₁₁ is selected from the group consisting of linear or branched, saturated and unsaturated, substituted or unsubstituted C₁-C₃ alkyl groups, C₁-C₃ hydroxyalkyl groups, and C₁-C₃ oxoalkyl groups.

18. The process of claim 17, wherein the modifying agent comprises citric acid.

19. A hydrocracking catalyst comprising a base of alumina, an amorphous silicia-alumina, a USY zeolite, a beta zeolite, and ZSM-12.

20. The hydrocracking catalyst of claim 19, wherein the base comprises 5 to 40 wt. % alumina, 30 to 70 wt. % ASA, 0.5 to 40 wt. % USY zeolite, 0.5 to 40 wt. % beta zeolite, and 0.1 to 40 wt. % ZSM-12.

21. The hydrocracking catalyst of claim 20, wherein the amount of alumina ranges from about 20 to about 30 wt. %.

22. The hydrocracking catalyst of claim 20, wherein the amount of ASA ranges from about 45 to about 75 wt. %.

23. The hydrocracking catalyst of claim 20, wherein the amount of USY zeolite ranges from about 4 to about 20 wt. %.

24. The hydrocracking catalyst of claim 20, wherein the amount of beta zeolite ranges from about 4 to 20 wt. %.

25. The hydrocracking catalyst of claim 20, wherein the amount of ZSM-12 ranges from about 2 to about 20 wt. %.

26. The hydrocracking catalyst of claim 19, wherein the catalyst comprises the metals nickel (Ni) and tungsten (W) impregnated into the base.

27. The hydrocracking catalyst of claim 26, wherein the catalyst comprises from 2 to 10 wt. % of nickel material and from 8 to 40 wt. % of tungsten material based on the bulk dry weight of the hydrocracking catalyst.

28. The hydrocracking catalyst of claim 19, wherein the catalyst comprises a modifying agent.

29. The hydrocracking catalyst process of claim 28, wherein the modifying agent is selected from the group consisting of compounds represented by structures (1) through (4), and condensated forms thereof: 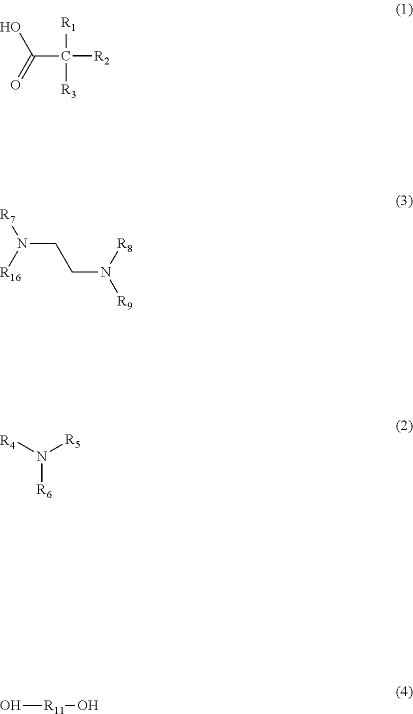
wherein:
(1) R₁, R₂ and R₃ are independently selected from the group consisting of hydrogen; hydroxyl; methyl; amine; and linear or branched, substituted or unsubstituted C₁-C₃ alkyl groups, C₁-C₃ alkenyl groups, C₁-C₃ hydroxyalkyl groups, C₁-C₃ alkoxyalkyl groups, C₁-C₃ aminoalkyl groups, C₁-C₃ oxoalkyl groups, C₁-C₃ carboxyalkyl groups, C₁-C₃ aminocarboxyalkyl groups and C₁-C₃ hydroxycarboxyalkyl groups;
(2) R₄ through R₁₀ are independently selected from the group consisting of hydrogen; hydroxyl; and linear or branched, substituted or unsubstituted C₂-C₃ carboxyalkyl groups; and
(3) R₁₁ is selected from the group consisting of linear or branched, saturated and unsaturated, substituted or unsubstituted C₁-C₃ alkyl groups, C₁-C₃ hydroxyalkyl groups, and C₁-C₃ oxoalkyl groups.

30. The hydrocracking catalyst of claim 28, wherein the modifying agent comprises citric acid.

31. The hydrocracking catalyst of claim 19, wherein the catalyst in the hydrocracking unit is prepared by:
(a) forming an extrudable mass containing the catalyst base;
(b) extruding the mass to form a shaped extrudate;
(c) calcining the mass to form a calcined extrudate;
(d) preparing an impregnation solution containing at least one metal nitrate or metal carbonate, a modifying agent, a solvent, and an ammonium containing component, and adjusting the pH of the impregnation solution to between 1 and 5.5 with a hydroxide base, inclusive;
(e) contacting the shaped extrudate with the impregnation solution; and
(f) drying the impregnated extrudate at a temperature sufficient to remove the impregnation solution solvent, to form a dried impregnated extrudate.

32. The hydrocracking catalyst of claim 31, wherein the impregnation solution comprises nickel carbonate.

33. The hydrocracking catalyst of claim 31, wherein the modifying agent is selected from the group consisting of compounds represented by structures (1) through (4), and condensated forms thereof: 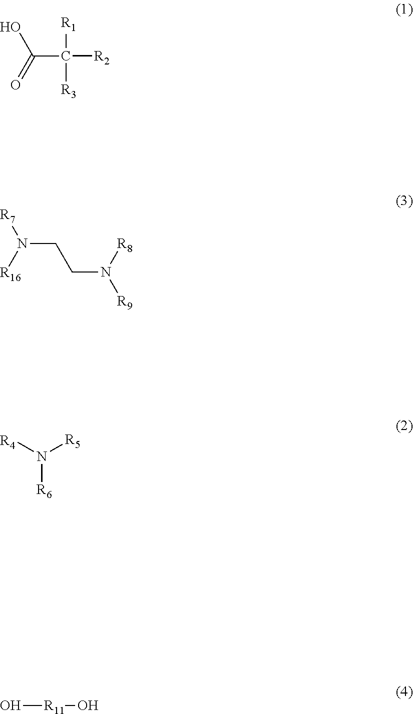
wherein:
(1) R₁, R₂ and R₃ are independently selected from the group consisting of hydrogen; hydroxyl; methyl; amine; and linear or branched, substituted or unsubstituted C₁-C₃ alkyl groups, C₁-C₃ alkenyl groups, hydroxyalkyl groups, C₁-C₃ alkoxyalkyl groups, C₁-C₃ aminoalkyl groups, C₁-C₃ oxoalkyl groups, C₁-C₃ carboxyalkyl groups, C₁-C₃ aminocarboxyalkyl groups and C₁-C₃ hydroxycarboxyalkyl groups;
(2) R₄ through R₁₀ are independently selected from the group consisting of hydrogen; hydroxyl; and linear or branched, substituted or unsubstituted C₂-C₃ carboxyalkyl groups; and
(3) R₁₁ is selected from the group consisting of linear or branched, saturated and unsaturated, substituted or unsubstituted C₁-C₃ alkyl groups, C₁-C₃ hydroxyalkyl groups, and C₁-C₃ oxoalkyl groups.

34. The hydrocracking catalyst of claim 33, wherein the modifying agent comprises citric acid.
